(19) United States
(12) Patent Application Publication
(10) Pub. No.: US 2025/0201111 A1
(43) Pub. Date: Jun. 19, 2025

(54) SERVER SYSTEM, SERVER, INFORMATION PROVIDING METHOD, AND COMPUTER-READABLE MEDIUM

(71) Applicant: NEC Corporation, Minato-ku, Tokyo (JP)

(72) Inventors: Shuhei MIZUGUCHI, Tokyo (JP); Kosei KOBAYASHI, Tokyo (JP); Shuei YAMADA, Tokyo (JP); Shintaro CHIKU, Tokyo (JP); Masanori KUKI, Tokyo (JP); Naoko FUKUSHI, Tokyo (JP)

(73) Assignee: NEC Corporation, Minato-ku, Tokyo (JP)

(21) Appl. No.: 18/848,637

(22) PCT Filed: Mar. 30, 2022
(86) PCT No.: PCT/JP2022/016138

§ 371 Date: Sep. 19, 2024

(51) Int. Cl. G08G 1/01; G06V 20/56; G08G 1/04

(52) U.S. Cl. CPC G08G 1/0112; G06V 20/588; G08G 1/04

(57) ABSTRACT

A reception means receives information from at least one of a mobile body, a roadside device, and an on-road facility. A determination means determines whether or not to transmit the received information to a second server on the basis of the received information. A transmission means transmits the information to the second server when it is determined to transmit the information to the second server.

### TECHNICAL FIELD

The present disclosure relates to a server system, a server, an information providing method, and a computer-readable medium.

### BACKGROUND ART

As a related art, Patent Literature 1 discloses an information processing device installed in a mobile body such as an automobile. The information processing device acquires sensor information from a sensor such as an imaging device. The information processing device recognizes a scene of the mobile body on the basis of the acquired sensor information. A scene of the mobile body includes a scene related to a traveling situation of the mobile body such as traveling on a general road, and a scene related to an environmental situation of the mobile body such as weather and a road surface situation.

In a case where the information processing device recognizes a scene of the mobile body, the information processing device sets, for scene information including the sensor information used for recognizing the scene, one or more labels corresponding to element information included in the scene information. The information processing device determines, on the basis of the set label, whether or not to retain the scene information for which the label is set. The information processing device stores the scene information determined to be retained in a storage unit. Furthermore, the information processing device transmits the scene information retained in the storage unit to an information processing server.

### CITATION LIST

### Patent Literature

Patent Literature 1: Japanese Unexamined Patent Application Publication No. 2020-101960

### SUMMARY OF INVENTION

### Technical Problem

In Patent Literature 1, the information processing device can select scene information to be stored on the basis of the set label, and can reduce the data amount of the scene information to be stored. Furthermore, since the information processing device transmits the scene information selected on the basis of the label to the information processing server, the data capacity managed by the information processing server can be saved. However, in Patent Literature 1, it is necessary to recognize the scene in each vehicle. Therefore, in Patent Literature 1, it is necessary to install an information processing device having high processing capability in each vehicle.

In view of the above circumstances, an object of the present disclosure is to provide a server system, a server, an information providing method, and a computer-readable medium capable of reducing the amount of information transmitted to a server that is a transmission destination of information without requiring an information processing device having high processing capability in a transmission source of the information.

### Solution to Problem

In order to achieve the above object, the present disclosure provides a server system as a first aspect. The server system includes a first server configured to receive information from at least one of a mobile body, an on-road facility, and a roadside device, and a second server configured to receive the information from the first server. The first server includes: a reception means for receiving information from at least one of the mobile body, the on-road facility, and the roadside device; a determination means for determining whether or not to transmit the received information to the second server on the basis of the received information; and a transmission means for transmitting the information to the second server when it is determined to transmit the information to the second server.

The present disclosure provides a server as a second aspect. The server includes: a reception means for receiving information from at least one of a mobile body, an on-road facility, and a roadside device; a determination means for determining whether or not to transmit the received information to another server on the basis of the received information; and a transmission means for transmitting the information to the other server when it is determined to transmit the information to the other server.

The present disclosure provides an information providing method as a third aspect. An information providing method includes: receiving information from at least one of a mobile body, an on-road facility, and a roadside device; determining whether or not to transmit the received information to another server on the basis of the received information; and transmitting the information to the other server when it is determined to transmit the information to the other server.

The present disclosure provides a computer-readable medium as a fourth aspect. A computer-readable medium stores a program for causing a computer to execute receiving information from at least one of a mobile body, an on-road facility, and a roadside device, determining whether or not to transmit the received information to another server on the basis of the received information, and transmitting the information to the other server when it is determined to transmit the information to the other server.

### Advantageous Effects of Invention

The server system, the server, the information providing method, and the computer-readable medium according to the present disclosure can reduce the amount of information transmitted to a server that is a transmission destination of information without requiring an information processing device having high processing capability as a transmission source of the information.

### BRIEF DESCRIPTION OF DRAWINGS

FIG. 1 is a block diagram illustrating a schematic configuration of a server system according to the present disclosure.

FIG. 2 is a block diagram illustrating a server system according to a first example embodiment of the present disclosure.

FIG. 3 is a block diagram illustrating a configuration example of an L-MEC server.

FIG. 4 is a block diagram illustrating a configuration example of a U-MEC server.

FIG. 5 is a sequence diagram illustrating an operation procedure in the server system.

FIG. 6 is a block diagram illustrating a configuration example of an L-MEC server used in a second example embodiment of the present disclosure.

FIG. 7 is a sequence diagram illustrating an operation procedure in a server system according to the second example embodiment.

FIG. 8 is a block diagram illustrating a configuration example of a computer device.

### EXAMPLE EMBODIMENT

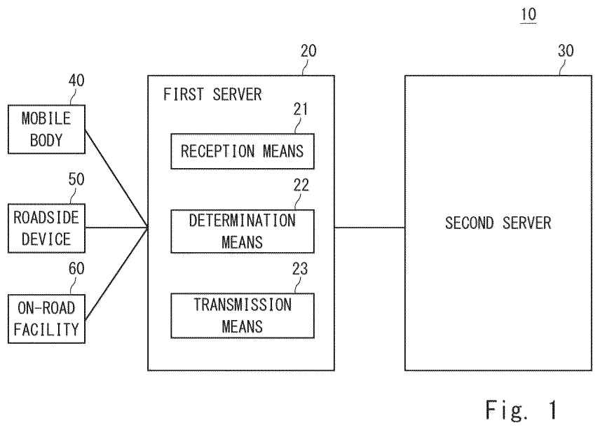

Before describing example embodiments of the present disclosure, an overview of the present disclosure will be described. FIG. 1 illustrates a schematic configuration of a server system according to the present disclosure. A server system 10 includes a first server 20 and a second server 30. The first server 20 receives information from at least one of a mobile body 40, a roadside device 50, and an on-road facility 60. The second server 30 receives information from the first server 20.

The first server 20 includes a reception means 21, a determination means 22, and a transmission means 23. The reception means 21 receives information from the mobile body 40, the roadside device 50, or the on-road facility 60. The determination means 22 determines whether or not to transmit the received information to the second server 30 on the basis of the information received by the reception means 21. When the determination means 22 determines to transmit the information to the second server 30, the transmission means 23 transmits the information received by the first server 20 to the second server 30.

In the present disclosure, the first server 20 determines whether or not to transmit information to the second server 30 according to the received information. The second server 30 receives, from the first server 20, information determined to be transmitted by the first server 20. In the present disclosure, since the first server 20 determines the necessity of information transmission to the second server, the mobile body 40, the roadside device 50, and the on-road facility 60 do not need to have an information processing device for determining the necessity of information transmission to the server. Therefore, the server system according to the present disclosure can reduce the amount of information received by the second server 30 even when an information processing device having high processing capability is not installed in the transmission source of information. Furthermore, in the present disclosure, unnecessary transmission of information to the second server 30 can be prevented, and a network load in information transmission and a processing load of the second server 30 can be reduced.

Hereinafter, example embodiments according to the present disclosure will be described in detail with reference to the drawings. Note that the following description and drawings are omitted and simplified as appropriate for clarity of description. Furthermore, the same elements and similar elements are denoted by the same reference symbols in the drawings below, and redundant descriptions are omitted as necessary.

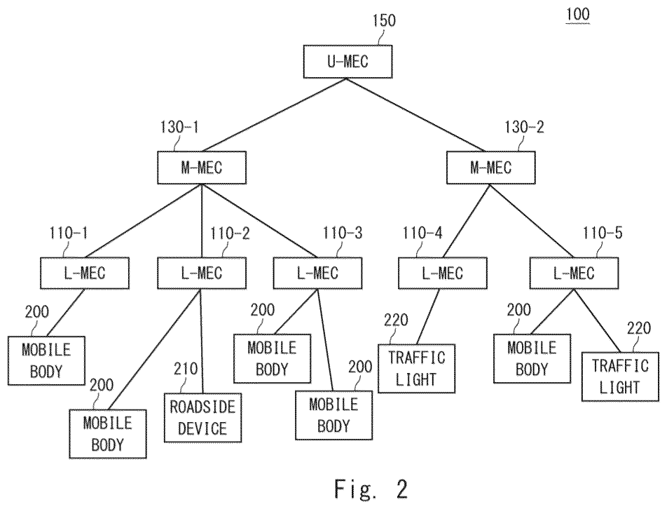

FIG. 2 illustrates a server system according to a first example embodiment of the present disclosure. A server system 100 includes a plurality of layered servers. The plurality of layered servers includes servers 110-1 to 110-5 of the first layer, servers 130-1 and 130-2 of the second layer, and a server 150 of the third layer. In the present example embodiment, the server system 100 is configured as a road maintenance management system or another system. Note that FIG. 2 illustrates an example in which the server system 100 includes five servers of the first layer, two servers of the second layer, and one server of the third layer, but the present example embodiment is not limited thereto. The server system 100 may have a desired number of first layer servers, a desired number of second layer servers, and a desired number of third layer servers.

In the following description, it is assumed that a multi-access/mobile edge computing (MEC) server is used as the server of each layer. The MEC servers have a multi-layer structure, that is, a multistage configuration. The servers 110-1 to 110-5 of the first layer are also referred to as lower-layer MEC servers or L-MEC (lower-MEC) servers. In addition, the servers 130-1 and 130-2 of the second layer are also referred to as middle-layer MEC servers or M-MEC (middle-MEC) servers. The server 150 of the third layer is also referred to as an upper-layer server or a U-MEC (upper-MEC) server. In the following description, when there is no need to distinguish, the L-MEC servers 110-1 to 110-5 and the M-MEC servers 130-1 and 130-2 are also referred to as an L-MEC server 110 and an M-MEC server 130, respectively.

In a multistage MEC configuration, latency of communication can be reduced by arranging an application server near a terminal. In addition, backhaul traffic reduction, processing efficiency improvement, security improvement, and the like can be achieved. In the case of a multistage configuration, it is conceivable that an MEC server having fewer usable resources is arranged in a layer closer to the user, that is, in a lower layer, and an MEC server having more usable resources, that is, having higher performance is arranged in a higher layer. This is because detailed analysis processing, that is, analysis processing with a high processing load needs to be performed in an upper-layer MEC server.

The L-MEC server 110 receives information from a mobile body 200, a roadside device 210, and a traffic light 220. The mobile body 200, the roadside device 210, and the traffic light 220 transmit, for example, video data to the L-MEC server 110. The mobile body 200 is configured as, for example, a land vehicle such as an automobile, a two-wheeled vehicle, a bus, a taxi, or a truck. The mobile body 200 may be a train, a ship, or an aircraft, or may be a mobile robot such as an automated guided vehicle (AGV). The mobile body 200 may be configured such that automated driving or autonomous driving is possible on the basis of information from a sensor installed in the mobile body.

The mobile body 200 transmits, for example, video data of an in-vehicle camera to the L-MEC server 110. For example, the mobile body 200 transmits video data obtained by imaging the traveling direction of the mobile body to the L-MEC server 110. Alternatively, the mobile body 200 may transmit video data obtained by imaging the inside of the mobile body to the L-MEC server 110. The mobile body 200 may include a plurality of in-vehicle cameras having different imaging directions, and transmit video data of the plurality of in-vehicle cameras to the L-MEC server 110. The mobile body 200 may transmit information such as position information and speed information to the L-MEC server 110 instead of the video data or in addition to the video data. The mobile body 200 corresponds to the mobile body 40 illustrated in FIG. 1.

The roadside device 210 is a communication device installed on a road. The roadside device 210 can communicate with a mobile body passing through a road and a terminal device of a pedestrian. The roadside device 210 includes a camera that images mobile bodies passing through the road. The roadside device 210 transmits, for example, video data imaged by using a camera to the L-MEC server 110. The roadside device 210 may include a roadside sensor other than a camera, and may transmit sensor data of the roadside sensor to the L-MEC server 110. The roadside device 210 corresponds to the roadside device 50 illustrated in FIG. 1.

The traffic light 220 is an on-road facility installed at an intersection or the like. The traffic light 220 includes a camera that images mobile bodies and pedestrians passing through the intersection. The traffic light 220 transmits, for example, video data imaged by using a camera to the L-MEC server 110. The traffic light 220 may include a sensor other than a camera, and may transmit sensor data acquired by the sensor to the L-MEC server 110. In addition, the traffic light 220 may transmit information indicating a light state of the traffic light to the L-MEC server 110. The traffic light 220 corresponds to the on-road facility 60 illustrated in FIG. 1.

The L-MEC server 110 receives information from the mobile body 200, the roadside device 210, and the traffic light 220 via a network. The network may include, for example, a wireless communication network using a communication line standard such as a 4th generation mobile communication system or long term evolution (LTE). The network may include a wireless communication network, such as WiFi (registered trademark), or 5th generation mobile communication system (5G), or local 5G. The video data received by the L-MEC server 110 may be a moving image or a still image.

Each L-MEC server 110 is arranged, for example, corresponding to a base station of a wireless communication network. For example, the L-MEC server 110 is connected to a base station (gNB: next generation NodeB) in the 5G wireless communication network via a user plane function (UPF). Each base station is connected to a 5th generation core network (5GC) via a UPF. The 5GC may be connected to an external network.

The mobile body 200 or a communication apparatus installed in the mobile body is connected to a communicable base station among a plurality of base stations. The mobile body 200 transmits information such as video data to the L-MEC server 110 corresponding to the base station to which the mobile body is connected. For example, the mobile body 200 travels on a road while accumulating camera images. When the mobile body 200 enters the communicable range of a base station, the mobile body transmits the camera image accumulated so far to the L-MEC server 110 accompanying the base station. The timing at which the mobile body 200 transmits information to the L-MEC server 110 is not particularly limited to the above-described timing.

The roadside device 210 and the traffic light 220 are connected to a communicable base station among the plurality of base stations. The roadside device 210 and the traffic light 220 transmit information such as video data to the L-MEC server 110 corresponding to the connected base station. The roadside device 210 and the traffic light 220 may transmit an image to, for example, the L-MEC server 110 at a geographically closest position. The roadside device 210 and the traffic light 220 may transmit information to the L-MEC server 110 via a wireless network or may transmit information to the L-MEC server 110 via a wired network.

The M-MEC server 130 is a server of a middle layer that has control over one or more L-MEC servers 110. The U-MEC server 150 is a server of an upper layer that has control over one or more M-MEC servers 130. The M-MEC server 130 and the U-MEC server 150 may be servers connected to the 5GC or servers connected to an external network, such as cloud servers.

The L-MEC server 110 determines whether or not to transmit the information received from the mobile body 200, the roadside device 210, and the traffic light 220 to an upper-layer server, that is, the M-MEC server 130 or the U-MEC server 150. The M-MEC server 130 and the U-MEC server 150 perform analysis processing on the information received from the L-MEC server 110. The analysis processing performed in the M-MEC server 130 and the U-MEC server 150 includes, for example, analysis processing of a road surface condition.

In the present example embodiment, the L-MEC server 110 corresponds to the first server 20 illustrated in FIG. 1. The M-MEC server 130 or the U-MEC server 150 corresponds to the second server 30 illustrated in FIG. 1.

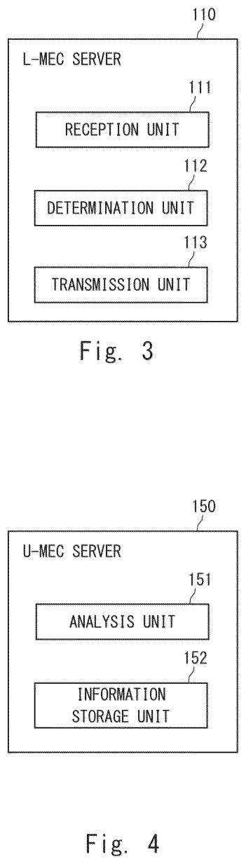

FIG. 3 illustrates a configuration example of the L-MEC server 110. The L-MEC server 110 includes a reception unit 111, a determination unit 112, and a transmission unit 113. The L-MEC server 110 includes, for example, one or more processors and one or more memories. At least some of the functions of each unit in the L-MEC server 110 can be implemented by the processor executing processing according to a program read from the memory.

The reception unit 111 receives information from at least one of the mobile body 200, the roadside device 210, and the traffic light 220. The reception unit 111 may receive information from a plurality of mobile bodies 200. Furthermore, the reception unit 111 may receive information from a plurality of roadside devices 210, or may receive information from a plurality of traffic lights 220. The reception unit 111 corresponds to the reception means 21 illustrated in FIG. 1.

On the basis of the information received by the reception unit 111, the determination unit 112 determines whether or not to transmit the information to an upper-layer server. On the basis of video data included in the received information, for example, the determination unit 112 determines whether or not to transmit the information to the M-MEC server 130 or the U-MEC server 150. When the determination unit 112 determines to transmit information, the transmission unit 113 transmits the information received by the reception unit 111 to the M-MEC server 130 or the U-MEC server 150. The determination unit 112 corresponds to the determination means 22 illustrated in FIG. 1. The transmission unit 113 corresponds to the transmission means 23 illustrated in FIG. 1.

For example, the determination unit 112 determines whether or not the road surface appears in the video data. When determining that the road surface appears in the video data, the determination unit 112 determines to transmit the received information to the M-MEC server 130 or the U-MEC server 150. When determining that the road surface does not appear in the video data, the determination unit 112 determines not to transmit the received information to the M-MEC server 130 or the U-MEC server 150. In this case, the transmission unit 113 can transmit data from which the road surface condition can be analyzed by the M-MEC server 130 or the U-MEC server 150 to the M-MEC server 130 or the U-MEC server 150.

The determination unit 112 may obtain the ratio of the road surface appearing in the video data, and determine whether to transmit the information to the M-MEC server 130 or the U-MEC server 150 on the basis of the ratio. The determination unit 112 may determine to transmit the information to the M-MEC server 130 or the U-MEC server 150 when the ratio of the road surface is greater than or equal to a predetermined threshold. The determination unit 112 may determine not to transmit the information to the M-MEC server 130 or the U-MEC server 150 when the ratio of the road surface is less than the predetermined threshold. In this case, the transmission unit 113 can transmit information including a high ratio of road surface and therefore is useful for road surface analysis to the M-MEC server 130 or the U-MEC server 150.

The determination unit 112 may determine whether or not a person appears in the video data, and determine whether or not to transmit information to the M-MEC server 130 or the U-MEC server 150 depending on whether or not a person appears in the video data. For example, when determining that a person appears in the video data, the determination unit 112 determines not to transmit information to the M-MEC server 130 or the U-MEC server 150. The determination unit 112 may determine not to transmit information in a case where a person appears in a form in which an individual is identifiable in the video data. The determination unit 112 may determine to transmit information to the M-MEC server 130 or the U-MEC server 150 when determining that a person does not appear in the video data. If video data in which an individual is identifiable is transmitted to the M-MEC server 130 or the U-MEC server 150, strict information management in the server is required from the viewpoint of personal information protection. In a case where it is determined whether or not to transmit information depending on whether or not a person appears in the video data, the transmission unit 113 can transmit information that does not require protection of personal information to the M-MEC server 130 or the U-MEC server 150.

When the information received by the reception unit 111 is information requiring privacy consideration, the transmission unit 113 may mask a privacy-sensitive portion in the information and transmit partially masked information to the M-MEC server 130 or the U-MEC server 150. For example, when the face of a person is clearly shown in the video data, or when personal name identifiable information such as a name tag is shown in the video data, the transmission unit 113 may mask the face or an area of the name tag. Alternatively, the transmission unit 113 may mask the entire area of the person in the video data. When the vehicle license plate is shown in the video data, the transmission unit 113 may mask the area of the license plate.

Note that while the example in which the processing for protecting personal information is performed in the lower-layer L-MEC server 110 has been described above, the present example embodiment is not limited thereto. The determination as to whether or not the information transmitted from the mobile body 200, the roadside device 210, and the traffic light 220 includes information that needs to be considered for privacy, and the processing on the information that needs to be considered for privacy may be performed in an upper-layer server. For example, when the U-MEC server 150 is arranged on a cloud, the M-MEC server 130 may perform the determination and processing described above.

The M-MEC server 130 and the U-MEC server 150 receive the information transmitted by the transmission unit 113 of the L-MEC server 110. The M-MEC server 130 and the U-MEC server 150 can receive information from a plurality of L-MEC servers 110. The M-MEC server 130 and the U-MEC server 150 perform analysis processing on the received information. The M-MEC server 130 and the U-MEC server 150 can perform analysis processing by utilizing, for example, video data of in-vehicle cameras transmitted from many mobile bodies 200.

FIG. 4 illustrates a configuration example of the U-MEC server 150. The U-MEC server 150 includes an analysis unit 151 and an information storage unit 152. The configuration of the M-MEC server 130 may be similar to the configuration of the U-MEC server 150 illustrated in FIG. 4. The M-MEC server 130 and the U-MEC server 150 each include, for example, one or more processors and one or more memories. At least some of the functions of each unit in the M-MEC server 130 and the U-MEC server 150 can be implemented by the processor executing processing according to a program read from the memory.

The analysis unit 151 performs analysis processing on the information received from the L-MEC server 110. The analysis unit 151 analyzes, for example, at least one of a road surface condition, an accident situation, and a disaster occurrence situation. The analysis unit 15 may also be referred to as an analysis means. The information storage unit 152 stores information received from the L-MEC server 110. In addition, the information storage unit 152 stores an analysis result by the analysis unit 151. The information storage unit 152 may also be referred to as an information storage means.

For example, in the analysis of the road surface condition, the analysis unit 151 analyzes the video data included in the received information, and identifies the place where the road surface is deteriorated. The analysis unit 151 stores, for example, position information of a place where the road surface is deteriorated and video data of the place in the information storage unit 152 as information of a place requiring repair. Furthermore, for example, in the analysis of the accident situation, the analysis unit 151 analyzes video data included in the received information, and analyzes whether or not an accident has occurred. The analysis unit 151 may analyze the scale of the accident. The analysis unit 151 stores, for example, position information of a place where an accident has occurred and video data of the place in the information storage unit 152 as accident occurrence situation information.

In the analysis of the disaster occurrence situation, the analysis unit 151 analyzes the video data included in the received information, and analyzes whether or not fire, flood damage, wind damage, or the like has occurred. The analysis unit 151 stores, for example, position information of a place where a disaster has occurred and video data of the place in the information storage unit 152 as disaster occurrence situation information. The analysis unit 151 may transmit the analysis result and the video data to an external server. In addition, when the analysis processing is performed by the M-MEC server 130, the M-MEC server 130 may transmit the analysis result and the video data to the U-MEC server 150. In that case, the U-MEC server 150 may store the analysis result and the video data transmitted from the M-MEC server 130 in the information storage unit 152.

In the L-MEC server 110, the determination unit 112 (see FIG. 3) may determine whether or not the information received by the reception unit 111 is information related to a known analysis result analyzed by the analysis unit 151. When the received information is information related to a known analysis result, it is considered that an analysis result similar to the known analysis result can be obtained in the analysis processing on the received information. Therefore, it is considered that further analysis processing for information related to the known analysis result is unnecessary. When the received information is information related to a known analysis result, the determination unit 112 may determine not to transmit the received information to the M-MEC server 130 or the U-MEC server 150. In that case, in the M-MEC server 130 or the U-MEC server 150, it is possible to prevent redundant analysis processing from being performed, in which an analysis result that is similar to a known analysis result is obtained. When the received information is not information related to a known analysis result, the determination unit 112 may determine to transmit the received information to the M-MEC server 130 or the U-MEC server 150.

For example, after transmitting the information, the determination unit 112 may receive, from the M-MEC server 130 and the U-MEC server 150, information related to an analysis result, such as position information of a place requiring repair. The determination unit 112 may compare position information of the place where the information has been acquired with position information included in the information regarding the analysis result, and determine not to transmit the information in a case where the acquisition place of the information received by the reception unit 111 is the same as the place where the analysis result has already been obtained. In this case, it is possible to prevent information of the location from being transmitted, in which the analysis result has already been obtained to the M-MEC server 130 or the U-MEC server 150, and prevent redundant analysis from being performed by the M-MEC server 130 or the U-MEC server 150.

Furthermore, the determination unit 112 may determine whether or not to transmit the information according to whether the video data included in the received information is video data useful for analysis by the analysis unit 151. For example, a shadow and a puddle on a road surface may be obstacles to road surface analysis. The determination unit 112 may examine the presence or absence of a shadow on the road surface or a puddle on the road surface appearing in the video data, and determine whether or not to transmit information according to the presence or absence of a shadow or a puddle. The determination unit 112 may determine not to transmit the information to the M-MEC server 130 or the U-MEC server 150 when a shadow or a puddle appears in the video data. The determination unit 112 may determine to transmit the information to the M-MEC server 130 or the U-MEC server 150 when no shadow or puddle appears in the video data.

Furthermore, the determination unit 112 may examine the sizes of the shadow area and the puddle area on the road surface, and determine whether or not to transmit information depending on the size of the shadow area or the puddle area. When the area of the shadow is large or the area of the puddle is large, for example, the determination unit 112 may determine not to transmit the information to the M-MEC server 130 or the U-MEC server 150. The determination unit 112 may determine to transmit the information to the M-MEC server 130 or the U-MEC server 150 when the area of the shadow is small or the area of the puddle is small, for example. In this case, the transmission unit 113 can transmit information that does not interfere with the road surface analysis to the M-MEC server 130 or the U-MEC server 150.

The determination unit 112 may determine whether or not the video data is video data that can be analyzed by the analysis unit 151, and determine whether or not to transmit the information according to the result of the determination. When the video data is video data that can be analyzed by the analysis unit 151, for example, the determination unit 112 determines to transmit the received information to the M-MEC server 130 or the U-MEC server 150. When the video data is not video data that can be analyzed by the analysis unit 151, the determination unit 112 determines not to transmit the received information to the M-MEC server 130 or the U-MEC server 150. In this case, the transmission unit 113 can transmit information that can be subjected to road surface analysis to the M-MEC server 130 or the U-MEC server 150.

The determination unit 112 may estimate the accuracy of analysis in a case where analysis processing is performed on the video data in the analysis unit 151, and determine whether or not to transmit information according to the estimation result. When the analysis unit 151 can analyze the video data with accuracy of a predetermined accuracy or more, the determination unit 112 determines to transmit the received information to the M-MEC server 130 or the U-MEC server 150. When the analysis unit 151 cannot analyze the video data with accuracy of the predetermined accuracy or more, the determination unit 112 determines not to transmit the received information to the M-MEC server 130 or the U-MEC server 150. For example, the determination unit 112 determines not to transmit, to the M-MEC server 130 or the U-MEC server 150, video data in which the road surface appears in the video data but the degree of deterioration determination is estimated to be low due to the influence of rain or shadow. In this case, the transmission unit 113 can transmit video data on which the analysis processing can be performed with high accuracy to the M-MEC server 130 or the U-MEC server 150.

The determination unit 112 may further determine whether or not to transmit information on the basis of information acquired from an external source. For example, the determination unit 112 acquires sensor information of a weather sensor and weather information. The sensor information and the weather information can be acquired from, for example, an external server that manages information regarding weather. The determination unit 112 determines to transmit information to the M-MEC server 130 or the U-MEC server 150 when the weather is sunny or cloudy. The determination unit 112 determines not to transmit information to the M-MEC server 130 or the U-MEC server 150 when the weather is rainy or snowing, for example. In this case, the transmission unit 113 does not transmit, to the M-MEC server 130 or the U-MEC server 150, the video data in which the road surface is wet due to rain or the like and the analysis of the road surface degradation may not be performed properly.

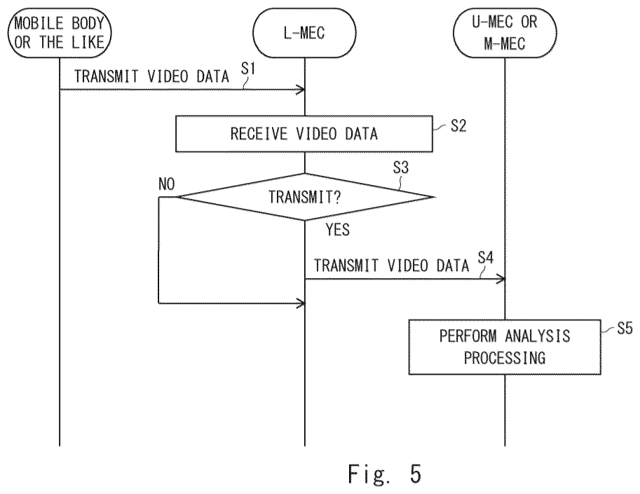

Next, an operation procedure will be described. FIG. 5 illustrates an operation procedure in the server system. The mobile body 200, the roadside device 210, or the traffic light 220 transmits information including video data to the L-MEC server 110 (step S1). In the L-MEC server 110, the reception unit 111 receives the information such as the video data transmitted in step S1 (step S2).

The determination unit 112 determines whether or not to transmit the information received in step S2 to an upper-layer server (step S3). When it is determined in step S3 to transmit information, the transmission unit 113 transmits the information including video data to the M-MEC server 130 or the U-MEC server 150 (step S4). Steps S2 to S4 correspond to the information providing method performed by the L-MEC server 110.

The M-MEC server 130 or the U-MEC server 150 receives information including video data from the L-MEC server 110. Here, it is assumed that the U-MEC server 150 receives information. The analysis unit 151 of the U-MEC server 150 performs analysis processing on the received information (step S5). In step S5, the U-MEC server 150 performs, for example, image analysis processing on the video data, and detects road surface deterioration or the like from the video data. The analysis unit 151 stores the analysis result and the video data in the information storage unit 152.

In the future, it is conceivable to utilize 5G wireless communication, transmit various data to a server such as a cloud server, and utilize the data in the cloud server. For example, it is conceivable that the cloud server collects video data and the like from the mobile body 200 that is traveling, the roadside device 210, and the traffic light 220, and performs data processing such as analysis of a road surface condition on the cloud. In that case, if all the video data is transmitted to the cloud server, a huge amount of data is collected in the cloud server, and the cloud server may not be able to process all the video data.

In the present example embodiment, the L-MEC server 110 receives information including video data, for example, from the mobile body 200, the roadside device 210, and the traffic light 220. In the L-MEC server 110, the determination unit 112 determines whether or not to transmit the received information to an upper-layer server on the basis of the received information. The M-MEC server 130 or the U-MEC server 150 receives the information determined to be transmitted to the upper-layer server in the L-MEC server 110 from the L-MEC server 110. In the present example embodiment, the L-MEC server 110 can select information to be transmitted to an upper-layer server, and it is possible to prevent a huge amount of information from being transmitted to the upper-layer server.

In the present example embodiment, whether or not information such as video data is to be transmitted to the M-MEC server 130 or the U-MEC server 150 is determined in the L-MEC server 110. Therefore, in the present example embodiment, the mobile body 200, the roadside device 210, or the traffic light 220 serving as the information transmission source does not need to have an information processing device for determining necessity of information transmission to the M-MEC server 130 or the U-MEC server 150. The server system 100 according to the present example embodiment can reduce the amount of information received by an upper-layer server even when an information processing device having high processing capability is not installed in the transmission source of information.

In the present example embodiment, a communication load between the L-MEC server 110 and the M-MEC server 130 or the U-MEC server 150 can be reduced as compared with a case where all information is transmitted to the M-MEC server 130 or the U-MEC server 150. In addition, in the present example embodiment, the M-MEC server 130 or the U-MEC server 150 does not need to analyze road surface deterioration or the like for all video data, and can reduce the processing load of analysis processing.

Next, a second example embodiment of the present disclosure will be described. The configuration of a server system according to the second example embodiment may be similar to the configuration of the server system 100 illustrated in FIG. 2. In addition, the configurations of a server 130 of the second layer and a server 150 of the third layer may be similar to the configuration of the U-MEC server 150 illustrated in FIG. 4.

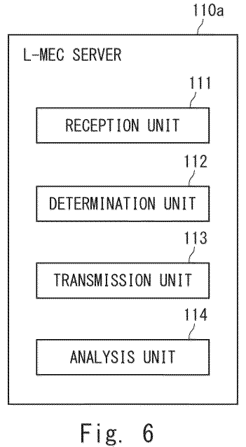

FIG. 6 illustrates a configuration example of an L-MEC server in the present example embodiment. An L-MEC server 110a includes an analysis unit 114 in addition to the configuration of the L-MEC server 110 illustrated in FIG. 3. The analysis unit 114 performs analysis processing on the information received by a reception unit 111. The analysis unit 114 analyzes, for example, at least one of a road surface condition, an accident situation, and a disaster occurrence situation. The analysis processing by the analysis unit 114 may be the same as the analysis processing performed by the analysis unit 151 (see FIG. 4) of the U-MEC server 150.

In the present example embodiment, in addition to or instead of the operation described in the first example embodiment, a determination unit 112 determines whether or not to process the received information by the L-MEC server 110a. In other words, the determination unit 112 determines whether or not it is necessary to immediately perform analysis processing on the received information. When determining that it is necessary to immediately perform the analysis processing, the determination unit 112 determines not to transmit the information received by the reception unit 111 to an upper-layer server. In that case, the determination unit 112 causes the analysis unit 114 to perform analysis processing. The analysis unit 114 performs analysis processing on the information received by the reception unit 111.

As an example, in a case where information with high real-time property is required, the determination unit 112 determines to immediately perform the analysis processing. As an example of a case where information with high real-time property is required, there is provision of information related to driving control of a self-driving vehicle. For example, in information provision related to driving control of a self-driving vehicle, analysis processing is performed on information such as image data in the L-MEC server 110a, and a result of the analysis processing is transmitted to the self-driving vehicle. On the other hand, in a case where the information is information intended for collecting information on the road or around the road, the determination unit 112 determines that it is not necessary to immediately perform the analysis processing. For example, in a case where the received information is information used for road maintenance management, the determination unit 112 determines that it is not necessary to immediately perform the analysis processing.

When determining that it is not necessary to immediately perform the analysis processing, the determination unit 112 determines whether or not to transmit the information received by the reception unit 111 to an upper-level server by the operation described in the first example embodiment. When determining that it is not necessary to immediately perform the analysis processing, the determination unit 112 may determine to transmit the information to an upper-layer server. When the information is transmitted to the upper-layer server, the analysis processing is performed by the M-MEC server 130 or the U-MEC server 150.

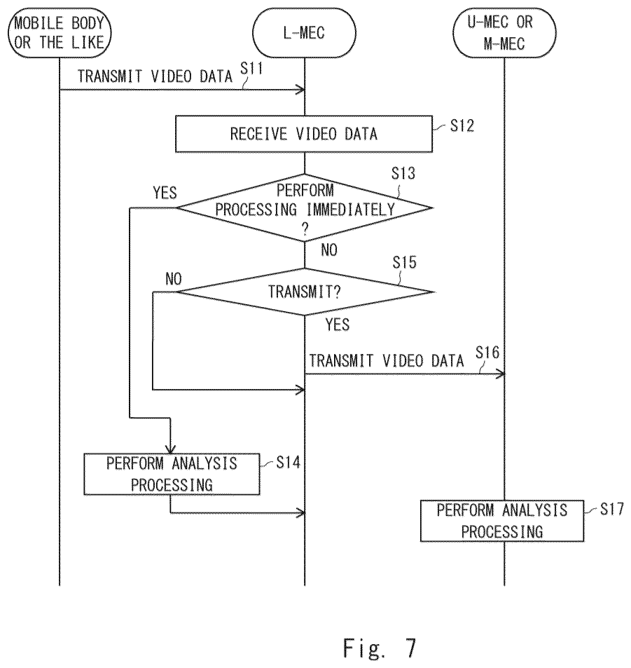

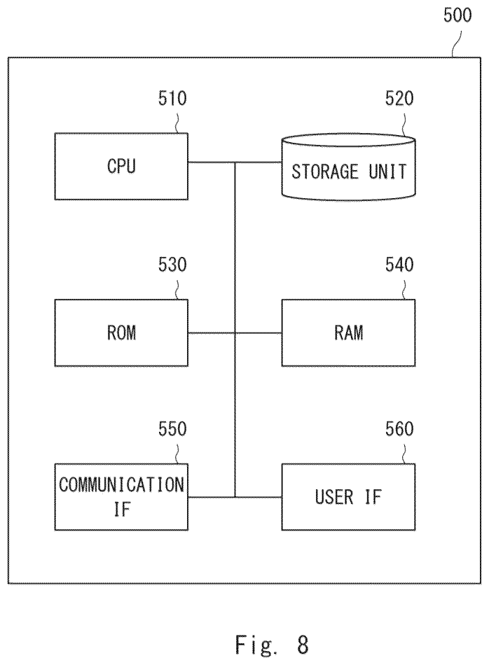

Next, an operation procedure in the present example embodiment will be described. FIG. 7 illustrates an operation procedure in the server system according to the present example embodiment. A mobile body 200, a roadside device 210, or a traffic light 220 transmits information including video data to the L-MEC server 110a (step S11). In the L-MEC server 110a, the reception unit 111 receives the information such as the video data transmitted in step S11 (step S12). Steps S11 and S12 may be similar to steps S1 and S2 illustrated in FIG. 5.

The determination unit 112 determines whether or not analysis processing should be immediately performed on the information received in step S12 (step S13). When determining that the analysis processing should be performed immediately, the determination unit 112 determines to perform the analysis processing in the L-MEC 110a without transmitting the information to an upper-layer server. When it is determined in step S13 that analysis processing should be performed immediately, the analysis unit 114 performs analysis processing on the information received in step S12 (step 14). When the analysis unit 114 performs the analysis processing, the transmission unit 113 may transmit a result of the analysis processing to the mobile body 200, the roadside device 210, or the traffic light 220 that is a transmission source of the information.

When determining that it is not necessary to immediately perform the analysis processing in step S13, the determination unit 112 determines whether or not to transmit the information received in step S12 to an upper-layer server (step S15). When the determination unit 112 determines to transmit the information to an upper-layer server, the transmission unit 113 transmits the information transmitted in step S12 to the M-MEC server 130 or the U-MEC server 150 (step S16). The M-MEC server 130 or the U-MEC server 150 receives information including video data from the L-MEC server 110a. Here, it is assumed that the U-MEC server 150 receives information. An analysis unit 151 of the U-MEC server 150 performs analysis processing on the received information (step S17). Steps S15 to S17 may be similar to steps S3 to S5 illustrated in FIG. 5.

In the present example embodiment, the determination unit 112 determines whether or not analysis processing needs to be performed immediately. When the determination unit 112 determines that the analysis processing needs to be performed immediately, the analysis unit 114 of the L-MEC server 110a performs the analysis processing on the received information. In the present example embodiment, the L-MEC server 110a that has received the information from the mobile body 200 or the like performs the analysis processing on the information for which the analysis processing needs to be performed immediately. In this case, as compared with a case where the analysis processing is performed in the M-MEC server 130 or the U-MEC server 150, the time required from the reception of the information to the acquisition of the analysis result can be shortened. Other effects are similar to those described in the first example embodiment.

Note that in the above example embodiment, an example has been described in which the L-MEC server 110 is the first server that performs the processing of determining whether or not to transmit information to an upper-layer server, and the M-MEC server 130 and the U-MEC server 150 are the second servers that perform the analysis processing. However, the present disclosure is not limited thereto. In the present disclosure, the processing of determining whether or not to transmit information may be performed using servers of a plurality of levels. In other words, the functions of the first server may be implemented in servers of a plurality of levels. For example, in FIG. 2, the L-MEC server 110 and the M-MEC server 130 may correspond to a first server that performs processing of determining whether or not to transmit information to an upper-level server.

In the server system having a multistage configuration as illustrated in FIG. 2, the plurality of layered servers may be functionally divided by each layer. For example, when a multistage MEC configuration is applied to a road maintenance management system, it may be determined whether or not a person appears in video data in a server of the first layer, and it may be determined whether or not information is information related to a known analysis result in a server of the second layer. In addition, the analysis processing may be performed in a server of the third layer. When no person appears in the video data, the server of the first layer, that is, the L-MEC server, transmits the received information to the server of the second layer. The L-MEC server does not transmit information when a person appears in the video data. The server of the second layer, that is, the M-MEC server, transmits the information to the server of the third layer, for example, if the received information is not information related to a known anomaly. The M-MEC server does not transmit information if the information is information related to a known anomaly. The server of the third layer, that is, the U-MEC server analyzes the received information for the presence or absence of an anomaly. The U-MEC server performs, for example, image analysis to analyze whether or not a road is cracked and whether or not a port hole is present in the road.

Here, it is unrealistic to concentrate the maintenance management related information and the like in one place from the device that is the transmission source of the information. In a case where information is concentrated in one place, when information that requires urgent processing is included in the received information, it may take time to collect the information. In addition, when a huge amount of data is transmitted to one place, communication traffic may increase. Furthermore, there is also a problem that it is necessary to process a huge amount of data in a server where information is concentrated. In the case of dividing the functions by each layer in the multistage MEC configuration as described above, the server system can respond to various demands. For example, security can be improved by determining not to transmit sensitive privacy information to the upper MEC server or cloud server in the lower MEC server. Alternatively, by performing analysis processing on information that requires immediate analysis processing by a lower MEC server and returning a result of the analysis processing to a layered transmission source, the physical transmission distance can be shortened, and communication latency can be reduced. The multistage MEC configuration has an advantage of scalability, as the number of servers in the middle layer can be increased or decreased according to a change in scale.

Next, a hardware configuration of the L-MEC server 110, the M-MEC server 130, and the U-MEC server 150 will be described. FIG. 8 illustrates a configuration example of a computer device that can be used as an MEC server. A computer device 500 includes a control unit (CPU) 510, a storage unit 520, a read only memory (ROM) 530, a random access memory (RAM) 540, a communication interface (IF) 550, and a user interface 560.

The communication interface 550 is an interface for connecting the computer device 500 to a communication network through a wired communication means, a wireless communication means, or the like. The user interface 560 includes, for example, a display unit such as a display. Furthermore, the user interface 560 includes an input unit such as a keyboard, a mouse, and a touch panel.

The storage unit 520 is an auxiliary storage device that can retain various types of data. The storage unit 520 is not necessarily a part of the computer device 500, and may be an external storage device or a cloud storage connected to the computer device 500 via a network.

The ROM 530 is a nonvolatile storage device. For example, a semiconductor storage device such as a flash memory having a relatively small capacity may be used for the ROM 530. A program that is executed by the CPU 510 may be stored in the storage unit 520 or the ROM 530. The storage unit 520 or the ROM 530 stores, for example, various programs for implementing functions of each unit of the L-MEC server 110, the M-MEC server 130, or the U-MEC server 150.

The program described above includes a group of commands or software codes for causing a computer to perform one or more functions described in the example embodiments when the program is read by the computer. The program may be stored in a non-transitory computer-readable medium or a tangible storage medium. As an example and not by way of limitation, a computer-readable medium or tangible storage medium includes a RAM, a ROM, a flash memory, a solid-state drive (SSD) or other memory technology, a compact disc (CD), a digital versatile disc (DVD), a Blu-ray (registered trademark) disk or another optical disk storage, a magnetic cassette, a magnetic tape, a magnetic disk storage, or another magnetic storage device. The program may be transmitted on a transitory computer-readable medium or a communication medium. As an example and not by way of limitation, the transitory computer-readable medium or the communication medium includes an electrical signal, an optical signal, an acoustic signal, or other forms of propagation signals.

The RAM 540 is a volatile storage device. As the RAM 540, various types of semiconductor memory devices such as a dynamic random access memory (DRAM) or a static random access memory (SRAM) may be used. The RAM 540 may be used as an internal buffer for temporarily storing data or the like. The CPU 510 loads a program, stored in the storage unit 520 or the ROM 530, in the RAM 540, and executes the loaded program. The function of each unit in the server can be implemented by the CPU 510 executing the programs. The CPU 510 may include an internal buffer in which data or the like can be temporarily stored.

Although example embodiments according to the present disclosure have been described above in detail, the present disclosure is not limited to the above-described example embodiments, and the present disclosure also includes those that are obtained by making changes or modifications to the above-described example embodiments without departing from the gist of the present disclosure. For example, the matters described in the above example embodiments can be appropriately combined.

For example, some or all of the example embodiments disclosed above can be described as, but not limited to, the following supplementary notes.

### [Supplementary Note 1]

A server system including:
a first server configured to receive information from at least one of a mobile body, an on-road facility, and a roadside device; and
a second server configured to receive the information from the first server,
in which the first server includes
a reception means for receiving information from at least one of the mobile body, the on-road facility, and the roadside device,
a determination means for determining whether or not to transmit the received information to the second server on the basis of the received information, and
a transmission means for transmitting the information to the second server when it is determined to transmit the information to the second server.

### [Supplementary Note 2]

The server system according to Supplementary Note 1, in which
the information includes video data, and
the determination means determines whether or not to transmit the information to the second server on the basis of the video data.

### [Supplementary Note 3]

The server system according to Supplementary Note 2, in which the determination means determines whether or not a road surface appears in the video data, and determines to transmit the information to the second server when determining that a road surface appears.

### [Supplementary Note 4]

The server system according to Supplementary Note 2 or 3, in which the determination means obtains a ratio of a road surface appearing in the video data, and determines whether or not to transmit the information to the second server on the basis of the obtained ratio.

### [Supplementary Note 5]

The server system according to any one of Supplementary Notes 2 to 4, in which the determination means checks presence or absence of at least one of a shadow on a road surface and a puddle on the road surface appearing in the video data, and determines whether or not to transmit the information to the second server according to presence or absence of at least one of the shadow and the puddle on the road surface.

### [Supplementary Note 6]

The server system according to any one of Supplementary Notes 2 to 5, in which the determination means determines whether or not a person appears in the video data, and determines not to transmit the information to the second server when determining that a person appears.

### [Supplementary Note 7]

The server system according to any one of Supplementary Notes 1 to 6, in which the second server includes an analysis means for analyzing the received information.

### [Supplementary Note 8]

The server system according to Supplementary Note 7, in which the determination means determines whether or not to transmit the information to the second server depending on whether or not the information is information that can be analyzed by the analysis means.

### [Supplementary Note 9]

The server system according to Supplementary Note 7 or 8, in which the determination means determines whether or not to transmit the information to the second server depending on whether or not the analysis means can analyze the information with accuracy of a predetermined accuracy or more.

### [Supplementary Note 10]

The server system according to any one of Supplementary Notes 7 to 9, in which the analysis means analyzes at least one of a road surface condition, an accident situation, and a disaster occurrence situation.

### [Supplementary Note 11]

The server system according to any one of Supplementary Notes 7 to 10, in which the second server further includes a storage means for storing the received information and an analysis result of the analysis means.

### [Supplementary Note 12]

The server system according to any one of Supplementary Notes 7 to 11, in which the determination means determines whether or not the information is information related to a known analysis result analyzed by the analysis means, and determines not to transmit the information to the second server when determining that the information is information related to the known analysis result.

### [Supplementary Note 13]

The server system according to any one of Supplementary Notes 1 to 12, in which the determination means determines whether or not to transmit the information to the second server also on the basis of information acquired from an external source.

### [Supplementary Note 14]

The server system according to any one of Supplementary Notes 1 to 13, in which the server system is a road maintenance management system.

### [Supplementary Note 15]

The server system according to any one of Supplementary Notes 1 to 14, in which the server system is configured as a server system including a plurality of servers separated into a plurality of layers, and the first server is a server in a layer lower than the second server.

### [Supplementary Note 16]

The server system according to Supplementary Note 15, in which the first server is arranged in a position closer to an acquisition source of the information than the second server.

### [Supplementary Note 17]

The server system according to Supplementary Note 15 or 16, in which the plurality of servers separated into the plurality of layers are functionally divided by each layer.

### [Supplementary Note 18]

The server system according to any one of Supplementary Notes 1 to 17, in which
the first server further includes an analysis means,
the determination means further determines whether or not to process the received information in the first server on the basis of the received information, and
the analysis means of the first server performs processing on the received information when the determination means determines to process the information in the first server.

### [Supplementary Note 19]

A server including:
a reception means for receiving information from at least one of a mobile body, an on-road facility, and a roadside device;
a determination means for determining whether or not to transmit the received information to another server on the basis of the received information;
and a transmission means for transmitting the information to the other server when it is determined to transmit the information to the other server.

### [Supplementary Note 20]

The server according to Supplementary Note 19, in which
the information includes video data, and
the determination means determines whether or not to transmit the information to the other server on the basis of the video data.

### [Supplementary Note 21]

The server according to Supplementary Note 20, in which the determination means determines whether or not a road surface appears in the video data, and determines to transmit the information to the other server when determining that a road surface appears.

### [Supplementary Note 22]

The server according to Supplementary Note 20 or 21, in which the determination means determines whether or not a person appears in the video data, and determines not to transmit the information to the other server when determining that a person appears.

### [Supplementary Note 23]

An information providing method including:
receiving information from at least one of a mobile body, an on-road facility, and a roadside device;
determining whether or not to transmit the received information to another server on the basis of the received information; and
transmitting the information to the other server when it is determined to transmit the information to the other server.

### [Supplementary Note 24]

A non-transitory computer-readable medium storing a program for causing a computer to execute
receiving information from at least one of a mobile body, an on-road facility, and a roadside device,
determining whether or not to transmit the received information to another server on the basis of the received information, and
transmitting the information to the other server when it is determined to transmit the information to the other server.

### REFERENCE SIGNS LIST

10 SERVER SYSTEM
20 FIRST SERVER
21 RECEPTION MEANS
22 DETERMINATION MEANS
23 TRANSMISSION MEANS
30 SECOND SERVER
40 MOBILE BODY
50 ROADSIDE DEVICE
60 ON-ROAD FACILITY
100 SERVER SYSTEM
110, 130, 150 SERVER
111 RECEPTION UNIT
112 DETERMINATION UNIT
113 TRANSMISSION UNIT
114 ANALYSIS UNIT
151 ANALYSIS UNIT
152 INFORMATION STORAGE UNIT
200 MOBILE BODY
210 ROADSIDE DEVICE
220 TRAFFIC LIGHT
500 COMPUTER DEVICE
510 CPU
520 STORAGE UNIT
530 ROM
540 RAM
550 COMMUNICATION INTERFACE
560 USER INTERFACE

What is claimed is:

1. A server system comprising:
a first server configured to receive information from at least one of a mobile body, an on-road facility, and a roadside device; and
a second server configured to receive the information from the first server,
wherein the first server comprises
at least one first memory storing first instructions; and
at least one first processor configured to execute the first instructions to:
receive information from at least one of the mobile body, the on-road facility, and the roadside device,
determine whether or not to transmit the received information to the second server on the basis of the received information, and
transmit the information to the second server when it is determined to transmit the information to the second server.

2. The server system according to claim 1, wherein
the information comprises video data, and
the at least one first processor is configured to execute the first instructions to determine whether or not to transmit the information to the second server on the basis of the video data.

3. The server system according to claim 2, wherein the at least one first processor is configured to execute the first instructions to determine whether or not a road surface appears in the video data, and determine to transmit the information to the second server when determining that a road surface appears.

4. The server system according to claim 2, wherein the at least one first processor is configured to execute the first instructions to obtain a ratio of a road surface appearing in the video data, and determine whether or not to transmit the information to the second server on the basis of the obtained ratio.

5. The server system according to claim 2, wherein the at least one first processor is configured to execute the first instructions to check presence or absence of at least one of a shadow on a road surface and a puddle on the road surface appearing in the video data, and determine whether or not to transmit the information to the second server according to presence or absence of at least one of the shadow and the puddle on the road surface.

6. The server system according to claim 2, wherein the at least one first processor is configured to execute the first instructions to determine whether or not a person appears in the video data, and determine not to transmit the information to the second server when determining that a person appears.

7. The server system according to claim 1, wherein the second server comprises at least one second memory storing second instructions, and at least one second processor configured to execute the second instructions to analyze the received information.

8. The server system according to claim 7, wherein the at least one first processor is configured to execute the first instructions to determine whether or not to transmit the information to the second server depending on whether or not the information is information that can be analyzed by the at least one second processor.

9. The server system according to claim 7, wherein the at least one first processor is configured to execute the first instructions to determine whether or not to transmit the information to the second server depending on whether or not the at least one second processor can analyze the information with accuracy of a predetermined accuracy or more.

10. The server system according to claim 7, wherein the at least one second processor is configured to execute the second instructions to analyze at least one of a road surface condition, an accident situation, and a disaster occurrence situation.

11. The server system according to claim 7, wherein the second server further comprises a storage for storing the received information and an analysis result.

12. The server system according to claim 7, wherein the at least one first processor is configured to execute the first instructions to determine whether or not the information is information related to a known analysis result analyzed by the at least one second processor, and determine not to transmit the information to the second server when determining that the information is information related to the known analysis result.

13. The server system according to claim 1, wherein the at least one first processor is configured to execute the first instructions to determine whether or not to transmit the information to the second server also on the basis of information acquired from an external source.

14. The server system according to claim 1, wherein the server system is a road maintenance management system.

15. The server system according to claim 1, wherein the server system is configured as a server system comprising a plurality of servers separated into a plurality of layers, and the first server is a server in a layer lower than the second server.

16. The server system according to claim 15, wherein the first server is arranged in a position closer to an acquisition source of the information than the second server.

17. The server system according to claim 15, wherein the plurality of servers separated into the plurality of layers are functionally divided by each layer.

18. The server system according to claim 1, wherein the at least one first processor is configured to execute the first instructions to:
determine whether or not the received information is processed in the first server on the basis of the received information, and
perform processing on the received information when it is determined that the received information is processed in the first server.

19. A server comprising:
at least one memory storing instructions; and
at least one processor configured to execute the instructions to:
receive information from at least one of a mobile body, an on-road facility, and a roadside device;
determine whether or not to transmit the received information to another server on the basis of the received information; and
transmit the information to the another server when it is determined to transmit the information to the another server.

20-22. (canceled)

23. An information providing method comprising:
receiving information from at least one of a mobile body, an on-road facility, and a roadside device;
determining whether or not to transmit the received information to another server on the basis of the received information; and
transmitting the information to the another server when it is determined to transmit the information to the another server.

24. (canceled)
